(19) United States
(12) Patent Application Publication
(10) Pub. No.: US 2026/0246986 A1
(43) Pub. Date: Aug. 20, 2026

(54) Content Manifest Delivery System

(71) Applicant: Comcast Cable Communications, LLC, Philadelphia, PA (US)

(72) Inventors: Ganesh Ranganathan, Chennai (IN); Vasanth Kumar KS, Chennai (IN); Kennan GB, Chennai (IN)

(21) Appl. No.: 19/059,029

(22) Filed: Feb. 20, 2025

(51) Int. Cl. H04N 21/2343; H04N 21/84

(52) U.S. Cl. CPC H04N 21/23439; H04N 21/8402

(57) ABSTRACT

Systems, apparatuses, and methods are described for providing content to a requesting device. A computing device may receive requests for versions of contents. Based on determining that a manifest received from a content source in response to a content request does not satisfy the content request (e.g., that the provided resolution of video files is lower than the requested resolution), the computing device may identify (e.g., from a stored database, and/or request and receive) a different manifest. That different manifest may be provided to a requesting device.

### BACKGROUND

Devices may request content, such as television shows, movies, and music, from content sources. Those content sources may stream the requested content to the requesting devices by breaking up the content into segments and delivering the content in those segments to the requesting devices over time. To help requesting devices access and play those segments, a content source may provide a manifest that describes the requested content, such as by providing information regarding video and audio segments (including the locations of those segments on a remote server), codecs, bitrates, timings, and the like. This segmented delivery may thereby allow the requesting device to output portions of the content (e.g., begin display of a requested television show) without downloading the entirety of the content.

### SUMMARY

The following summary presents a simplified summary of certain features. The summary is not an extensive overview and is not intended to identify key or critical elements.

Systems, apparatuses, and methods are described for a content delivery system using manifests. This process may involve dynamically delivering manifests to a requesting device based on whether the manifest satisfies a request from a requesting device and based on the availability of previously-received and stored manifests that are responsive to such a request. For example, a computing device may receive, from a requesting device (e.g., a gateway, a smartphone), a request for a first version of content (e.g., a 1080p version of a television show episode). The computing device may then request, from a content source, the first version of the content. The computing device may receive, from the content source, a first manifest corresponding to the content. That said, the manifest might not be responsive to the request: for example, the manifest may provide 720p and 480p segments of the content, but not 1080p segments for the content. The computing device may, based a difference between properties indicated in the first manifest (e.g., the 720p/480p segments) and properties corresponding to the first version of the content (e.g., the request for 1080p), and based on previous receipt of a second manifest corresponding to the content (e.g., the availability of a stored manifest detailing 1080p segments), send, to the requesting device, the second manifest. In this manner, the computing device might intercept what otherwise might provide a lesser quality of service to the requesting device and provide, instead, a manifest which enables the requesting device to access content at a desired level of quality.

As an example of how the above process may operate, if a requesting device requests content in a 1080p format, and if the manifest received from the content source details segments in a 720p format or lower, the computing device may identify a previously-received manifest corresponding to a 1080p format and transmit that previously-received manifest to the requesting device. That said, if the content source were to provide a manifest that satisfied a content request, then the manifest may be provided to the requesting device. For example, the computing device may receive a second request for a first version of a second content. The computing device may then request, from the content source, the first version of the second content and receive, from the content source, a third manifest corresponding to the second content. In such a circumstance, based on comparing the properties indicated in the third manifest (e.g., 1080p video segments) and properties corresponding to the first version of the second content (e.g., a request for 1080p video), the computing device may send, to the requesting device, the third manifest.

The manifest provided to a requesting computing device may have been received at a previous time. For example, a computing device may receive, from one or more content sources and in response to a request for content, a first manifest. That first manifest might be stored in a database along with other manifests, effectuating storage of a history of previously-received manifests. The computing device may then receive, from a requesting device and after receiving the first manifest, a request for a first version of content. The computing device may request, from the one or more content sources, the first version of the content and receive, from the one or more content sources, a second manifest corresponding to the content. The computing device may then send, based on comparing properties indicated in the first manifest and properties corresponding to the first version of the content, and to the requesting device, the first manifest (rather than, for example, the second manifest).

One of the many advantages of a manifest database is that it may allow for a computing device to provide manifests that satisfy a content request even when a content source provides a manifest that does not satisfy that request. With that said, even if a manifest provided by a content source is not responsive to a request, and even if the manifest database does not store a manifest responsive to the request, the computing device may be configured to request and retrieve such a manifest by sending additional requests to a content source. For example, a computing device may store, in a database, a plurality of manifests. Each of those plurality of manifests may have been received from one or more content sources in response to a content request. The computing device may receive, from the at least one of the one or more content sources and based on a request for a first version of content, a first manifest corresponding to the content. The computing device may then, based a difference between properties indicated in the first manifest and properties corresponding to the first version of the content, and based on a difference between properties corresponding to the stored plurality of manifests and the properties corresponding to the first version of the content, perform steps to acquire a manifest (e.g., a new manifest) responsive to the request. For example, the computing device may send, to the one or more content sources, a second request for the first version of the content. That second request may be modified relative to the first request: for example, it may be modified to prompt the content source to provide the requested manifest (e.g., might request 4K content to receive 1080p content), even if the content source would normally not provide such a manifest (e.g., when the content source would normally, in response to a request for 1080p content, provide a manifest indicating 720p segments). The computing device may then receive, from the one or more content sources, a second manifest that satisfies the properties corresponding to the first version of the content and send, to the requesting device, the second manifest.

In turn, another of the many advantages of the aspects described herein is that quality of service may be maintained even when content sources provide manifests that direct requesting devices to access content at a different format than what was originally requested. Content sources may respond to requests for content with different forms of that content for various reasons: for example, a content source might provide a manifest with only lower-quality segments of requested content to lower bandwidth costs, based on subscription agreements, due to various transmission policies associated with the content, or the like. This may be undesirable for users, as it can often mean that a lower quality form of content may be received. Aspects described herein implement storage of manifest files in a manner where, if a computing device identifies that a content source provided a non-responsive manifest file, a stored, potentially more responsive manifest file may be provided instead. Indeed, even where a responsive manifest file is not stored, the computing device may perform steps (e.g., generate and transmit additional content requests with different content) to acquire a responsive manifest file.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIG. 3 shows an example content delivery network.

FIG. 4 shows an example flowchart for steps involving providing manifests to a requesting device.

FIG. 5 shows an example database listing of manifests.

FIG. 6 shows an example of a manifest database.

FIG. 7 shows a messaging diagram illustrating a process for receiving additional manifests.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

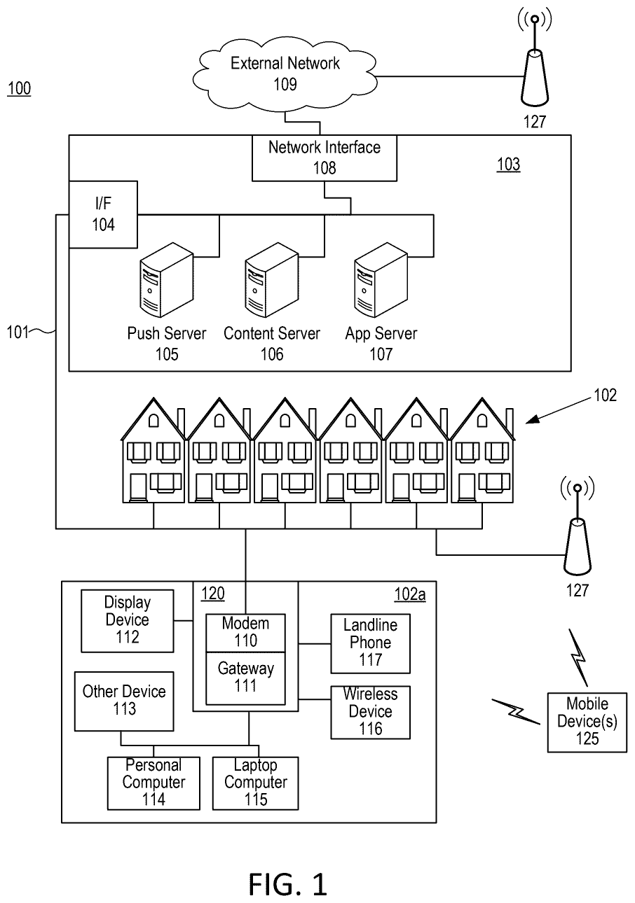

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional push, content, and/or application servers, and/or other types of servers. Although shown separately, the push server 105, the content server 106, the application server 107, and/or other server(s) may be combined. The servers 105, 106, and 107, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA)), landline phones 117 (e.g., Voice over Internet Protocol—VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on-or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

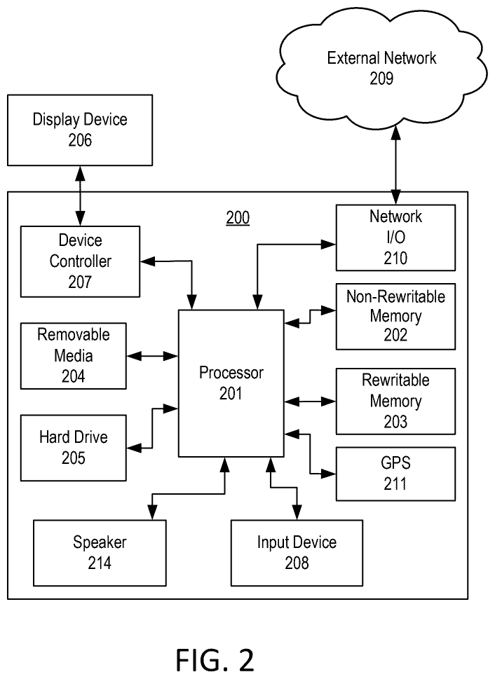

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein (e.g., one or more requesting devices, intermediary computing devices, content sources). The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

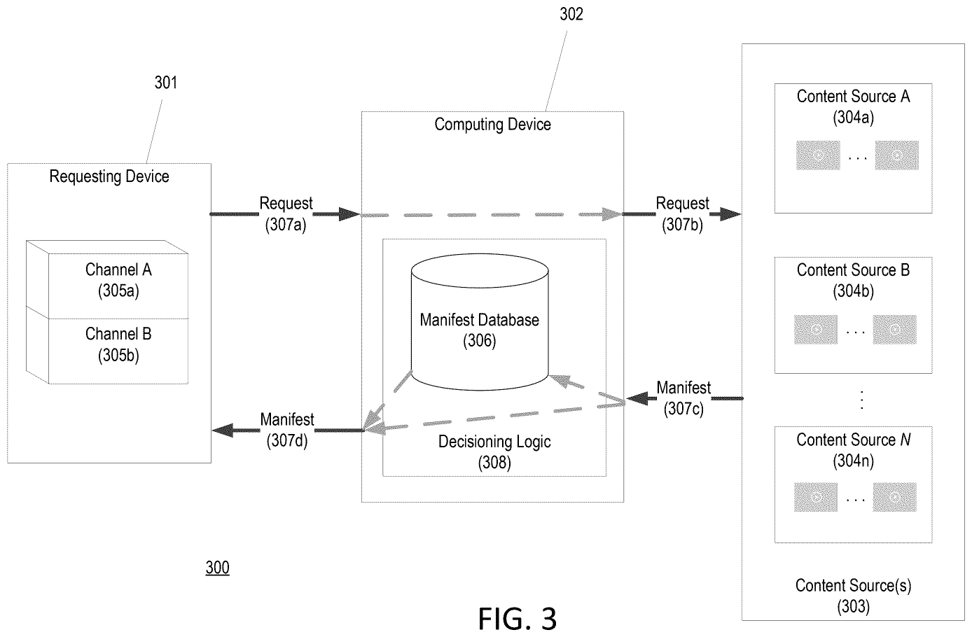

FIG. 3 shows an example content delivery network 300. The content delivery network 300 is shown as comprising a requesting device 301, a computing device 302, and one or more content sources 303. The requesting device 301, the computing device 302, and/or the one or more content sources 303 may comprise one or more computing devices, such as those described with respect to FIG. 1 and/or FIG. 2. For example, the requesting device 301 may comprise a gateway (e.g., a set-top box) connected to a display device such as a television, the computing device 302 may comprise a first server, and the one or more content sources 303 may comprise one or more servers (e.g., as part of a cloud storage solution). As another example, the computing device 302 may be a logical portion of a server that also provides all or portions of the one or more content sources 303 on a different logical portion of the server. The computing device 302 is shown as associated with a manifest database 306. While the manifest database 306 is shown in FIG. 3 as part of the computing device 302 for simplicity, the manifest database 306 need not be part of and/or internal to the computing device 302. For example, the manifest database 306 may be located on one or more other computing devices (not shown).

The requesting device 301 may be configured to send content requests and receive responses to those content requests. For example, the requesting device 301 may be a smartphone, laptop, desktop computer, gateway, or similar device capable of transmitting a request for content to the computing device 302 by accessing (e.g., using a user interface provided to a user) a channel, such as channel A 305a and/or channel B 305b. In such an example, the request for content may be a request for the content scheduled on a particular channel at a given time. Additionally and/or alternatively, the request for content may be a request for a particular content, such as a particular movie, television show, or song. In such a circumstance, a user might initiate a request for content from the requesting device 301 by, for example, using a user interface to select a user interface element corresponding to the content, which might thereby cause the requesting device 301 to transmit a request for content to the computing device 302.

In response to content requests, the requesting device 301 may receive manifests which may be used to access (e.g., stream) content. For example, upon receipt of a manifest, the requesting device may process the manifest to identify one or more content segments and request those content segments so as to effectuate streaming output of the content. In this manner, rather than downloading the entirety of the content, the requesting device 301 may download and output smaller segments of the content and, in turn, more quickly begin output of the content. Along those lines, the requesting device 301 may use the manifest to enable output of the content at any point in the content: for example, timing and/or segment information in the manifest may be usable by the requesting device 301 to allow users to start and/or resume playback of video and/or audio from virtually any point in the content.

The computing device 302 may comprise a device that may receive and/or send content requests, may receive manifests in response to content requests, and/or may determine which manifests, if any, to send to a requesting device. For example, the computing device 302 may be capable of receiving a content request from the requesting device 301, send a content request (which need not be identical to those received from the requesting device 301) to the one or more content sources 303, may be capable of receiving a manifest in response to that content request from the one or more content sources 303, and/or may be capable of sending a manifest (which need not be the same as that received from the one or more content sources 303) to the requesting device 301. In this manner, the computing device 302 may act as an intermediary and/or intercepting device, in effect managing a flow of content requests from the requesting device 301 and the flow of manifests received from the one or more content sources 303.

A manifest, which may be referred to as a manifest file or an MPD file (particularly in the context of Moving Picture Experts Group (MPEG) Dynamic Adaptive Streaming over HTTP (DASH) Media Presentation Description (MPD) files), may comprise information about content. For example, a manifest may comprise information about video and/or audio segments (e.g., a Uniform Resource Indicator (URI) for retrieving a segment, a length of the segment, a format of the segment, an ordering of the segment), information about a schema of the manifest, information about buffer(s) for content display, metadata corresponding to the content such as a title, source, copyright, description, and the like. Manifest files may describe (e.g., provide metadata regarding) segments for various versions of content: for example, a manifest may comprise information about both 480p segments and 720p segments of content and/or may comprise information about both High Dynamic Range (HDR) and Standard Dynamic Range (SDR) segments of content. That said, manifests might not comprise an authoritative listing of all segments available to a requesting device. For instance, a content source may remove, from a manifest, information about higher-quality (e.g., 1080p, 4K, HDR) segments of content before sending it to a requesting device in order to lower bandwidth needs, preserve processing capabilities, or the like. This can be undesirable, as it often means that users of such requesting devices receive lower quality video than is requested.

The computing device 302 is shown for the purposes of illustration as comprising decisioning logic 308 which may be used to determine which manifests to send to the requesting device 301. Such a determination may be based on the content of received manifests and the availability of manifests in the manifest database 306. For example, if the requesting device 301 requests a 1080p form of a television show episode but the one or more content sources 303 respond with a manifest only detailing segments of the episode in 480p, the requesting device 301 may query the manifest database 306 to determine whether a different manifest (e.g., one with higher-quality segments of the episode) is stored in the manifest database 306. If so, the stored manifest, even if old or received for a different requesting device, might be provided to the requesting device 301 instead. With that said, if no such manifest is stored, the computing device 302 may then take steps to send additional requests to the same or different content sources to acquire additional manifests that might be responsive to the request. As a different example, if the requesting device 301 requests a 720p form of a movie and the one or more content sources 303 respond with a manifest indicating portions of the movie in 720p, then that manifest might be sent along to the requesting device 301. In either circumstance (e.g., whether or not a manifest received from the one or more content sources 303 is sent to the requesting device 301), the computing device may be configured to store received manifests in the manifest database 306. In this manner, the manifest database 306 may be used by the computing device 302 as a repository of manifests for various content, thereby allowing the computing device 302 to provide manifests responsive to a request from the requesting device 301 even when manifests received from the one or more content sources 303 do not satisfy the request.

The one or more content sources 303 (including, for example, a variety of content sources, such as content source A 304a, content source B 304b, up to content source N 304n) may comprise one or more computing devices that provide content (e.g., portions of video, audio) and/or one or more manifests (e.g., manifests, such as MPEG DASH MPD files) corresponding to such content. For example, the one or more content sources may be configured to, in response to a request for content (e.g., a television show episode), respond with a manifest (e.g., an MPD file) that can be used by the requesting device 301 to request (e.g., from the one or more content sources 303 and/or another source, such as a third-party server) one or more portions of the content. That manifest may comprise URIs or similar data which enable a requesting device to access different segments of the requested content. That said, the source of a manifest need not be the same as the source of one or more portions of content: for example, one of the one or more content sources 303 may be configured to generate and/or transmit manifests, another one of the one or more content sources 303 may be configured to store a first portion of content, and yet another one of the one or more content sources 303 may be configured to store a second portion of the content.

As one example of how the processes described herein may operate, FIG. 3 depicts a flow whereby a content request 307a is sent from the requesting device 301 and to the computing device 302. The computing device may then send a corresponding content request 307b to the one or more content sources 303. The content request 307b need not be identical to the content request 307a. For instance, the content request 307a may lack authentication credentials, whereas the computing device 302a may insert authentication credentials into the content request 307a to create the content request 307b. As another example, the content request 307a may comprise additional content (e.g., identifying information corresponding to the requesting device 301) which may be removed by the computing device 302 to create the content request 307b so as to provide privacy to the requesting device 301. The one or more content sources 303 may respond to a content request, such as the content request 307b, with a manifest 307c. The manifest 307c may comprise information corresponding to one or more portions of content, such as portions of video or audio content, as well as codec information, timing information, and the like. The computing device 302 may receive the manifest 307c and may determine (e.g., based on the decisioning logic 308) whether to send the manifest 307c to the requesting device 301 or whether to provide a different manifest (e.g., from the manifest database 306 and/or from another request to the one or more content sources 303) to the requesting device 301. The computing device may then send the decided manifest to the requesting device 301 as the manifest 307d.

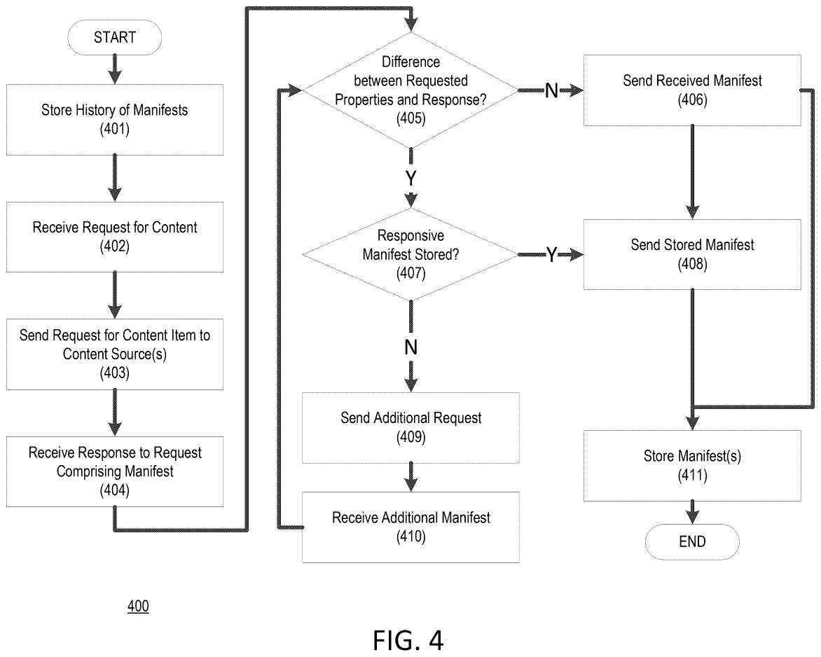

FIG. 4 shows an example flowchart for steps involving a method 400 for providing manifests to a requesting device. The steps depicted in FIG. 4 may be performed by one or more computing devices, such as the computing device 302, the requesting device 301, and/or the one or more content sources 303. The steps depicted in FIG. 4 are illustrative, and the various steps may be omitted, re-arranged, and/or modified as desired. For instance, FIG. 4 describes storage of a history of manifests; however, the process may begin without any manifests having been received or stored yet. As another example, various steps depicted in FIG. 4 may be omitted such that, for instance, if a responsive manifest is not received, then various fail states may occur (e.g., provision of a different but not entirely responsive manifest may occur).

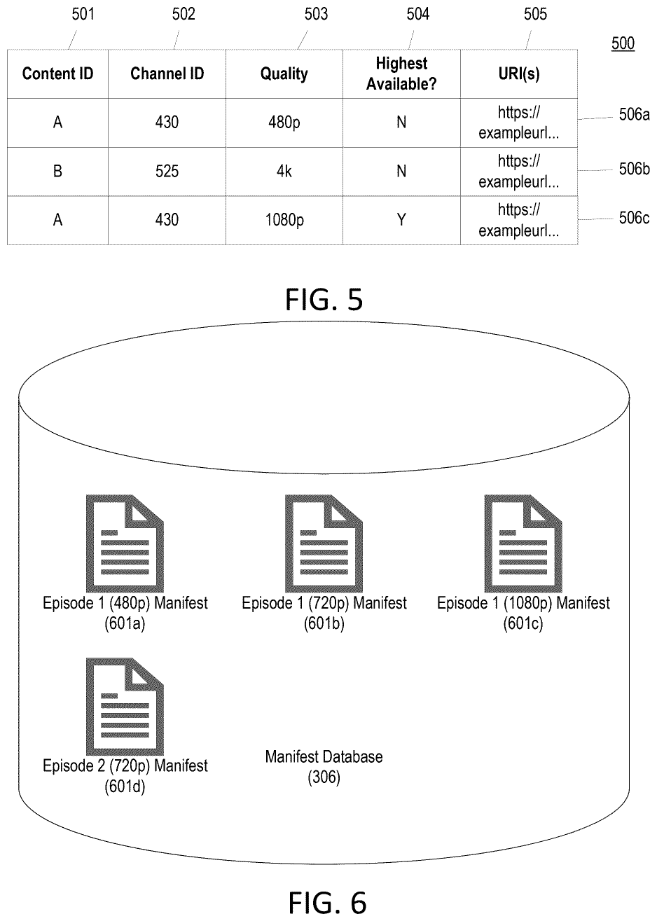

In step 401, a computing device may store a history of manifests. The process of storing a history of manifests may comprise maintaining a database (e.g., the manifest database 306) that stores various manifests for content (e.g., one or more movies, television shows, songs). Manifests may have been received and stored as part of content requests. For example, the computing device may store, in a database, a plurality of manifests, and each of the plurality of manifests may have been received from one or more content sources in response to a content request. Additionally and/or alternatively, manifests may be received and/or stored without regard to content requests. For example, the database may additionally and/or alternatively store manifests that were automatically downloaded from various content sources (e.g., third-party streaming services) on a periodic basis, and/or manifests that were uploaded by an administrator. Examples of how manifests might be stored by a database are described with respect to FIG. 5 and FIG. 6 below.

The history of manifests stored as part of step 401 may be time-limited and/or temporary. Content sources may modify over time: for example, content segment files might get moved to different locations in cloud storage, content may become available or unavailable due to licensing agreements, or the like. In turn, a manifest (e.g., one that points to particular URIs, contains particularized information about video and/or audio segments such as their length) might effectively expire or become unusable over time. All the same, it may be desirable to store older manifests because the one or more content sources 303 might not provide the right manifest requested: for example, if a user requests a 1080p version of a movie, the one or more content sources 303 might try to send a manifest detailing 720p segments of the movie due to bandwidth constraints perceived by the content source. In such a circumstance, an older (yet still valid) manifest stored in the manifest database 306 that details 1080p segments of the movie may be sent instead of the received manifest detailing 720p segments of the movie, as doing so ensures that a requesting device (e.g., the requesting device 301) receives what it asked for. That said, to avoid providing manifests that are unnecessarily old or otherwise invalid, the history of manifests might be periodically culled based on a time period, such as every week, every month, or the like. More broadly, manifests stored as part of the history of manifests may be periodically evaluated for accuracy and reliability. For example, one or more computing devices may, on a periodic basis, evaluate URIs provided by a manifest to ensure that the URIs are still valid and point to accessible content segments.

The history of manifests stored as part of step 401 need not be for a particular requesting device, content source, or the like. One of the many advantages of this approach is that the history of manifests (e.g., as stored in the manifest database 306) may maintain manifest information for a wide variety of content sources and regardless of which requesting devices requested content from those content sources. This may provide a more consistent user experience, as it means that user requests for particular forms of content (e.g., a movie in 1080p) can be better ensured even when some content sources (e.g., particularly popular content sources with many users) aggressively try to push devices to request lower-quality versions of content by, for example, omitting higher-quality segment information in manifests.

A different computing device may be configured to store information corresponding to a highest quality form of content indicated by the history of manifests. In some circumstances, a listing of the highest available quality of content may be generated and stored. This may allow the computing device to identify circumstances where a manifest received from a content source does not contain segments of the highest quality available to the content source (e.g., because the content source is attempting to limit bandwidth or for similar reasons). In turn, the computing device may be configured to, as part of storing a manifest, transmit all or portions of a manifest indicating the highest quality segments available to a different computing device for storage.

In step 402, the computing device may receive a request for content. For example, the computing device may receive, from a requesting device (e.g., the requesting device 301), a request for a version of content (e.g., a 1080p version of content, an HDR version of content, a high bitrate version of the content). A request may be associated with access, by a user, to a user interface element of a user interface provided by a requesting device. For example, the requesting device 301 may comprise a smartphone, and the request received in step 402 may have been generated based on a user interfacing (e.g., touching, clicking) a user interface element corresponding to content. Additionally and/or alternatively, the request for content may be received as part of access, by a requesting device such as the requesting device 301, to a channel. For example, the requesting device 301 may provide access to one or more channels (e.g., the channel A 305a and the channel B 305b), with each channel providing different content at different times (e.g., a schedule of various television show episodes, advertisements, and other content at various times throughout the day) based on a schedule. In turn, when a user selects a particular channel, then the requesting device 301 may be configured to request content based on that schedule. For example, at approximately the time that a television show episode is to air, the requesting device 301 may be configured to request the content, receive a manifest, and ultimately use the manifest to begin streaming the television show episode.

The request in step 402 may indicate a version (e.g., a resolution, bit rate, bit depth, dynamic range, codec, or similar parameters) of content. For example, the request may indicate a 1080p version of content, an HDR version of content, a high bitrate version of content, a mobile-friendly version of content, or the like. Such a format may be determined based on user input (e.g., a user manually selecting one of a variety of quality options, such as selecting a “high definition” option or a “mobile-friendly” version) and/or by the requesting device 301 (e.g., based on a resolution of an attached display device, based on a speed of a network connection of the requesting device 301). The request may, but need not, indicate a particular technical format. For instance, the request may be for a highest resolution available, but need not specify whether that highest resolution is 4K, 1080p, or the like.

In step 403, the computing device may send a request for the content to one or more content sources. For example, the computing device may request, from the one or more content sources 303, the content. The request may indicate a version of the content based on the request in step 402. For example, if a requesting device requests a 720p version of a movie as part of step 402, then the request sent in step 403 may request a 720p version of the movie from an appropriate content source.

The request sent in step 403 may be modified relative to the request received in step 402. For example, if the user requests a highest quality version of a video (e.g., in a manner that does not specify a particular resolution but implies a quality level, such as “smartphone resolution,” “web browser”), the computing device may modify the request to indicate more technically specific information (e.g., 4K, 1080p, HDR, SDR, high bit rate, low bit rate). Such modification of the request may be performed to ensure compatibility with content sources, to fulfill service obligations (e.g., to not provide 4K streams to users paying only for a 1080p streaming service), or the like. The request may be modified based on a recipient of a content source. For example, content sources known to provide manifests that are not fully responsive to requests (e.g., content sources that regularly provide 480p-only manifests in response to requests for 720p content) may be provided modified requests that are more likely to result in the requested content (e.g., the request may be for 1080p content, making the content source more likely to respond with the requested 720p content).

As will be also described with respect to step 409, the request sent in step 403 may be modified to prompt a content source to provide a desired manifest, even if the content source would not ordinarily provide such a manifest. Some content sources may attempt to preserve bandwidth and/or manage user access by not directly providing content in a requested format. For example, if a particular content source receives a request for a HDR400 version of a movie, the content source may provide a manifest file with only SDR segments of the movie, even if HDR400 is otherwise available. With that said, if the same content server receives a request for a HDR1000 version of the same movie, it might provide a response with a manifest file comprising HDR400 segments of the movie. In turn, as part of step 403, the computing device may generate a request that is intended to cause the content source to output the desired manifest file, even if the request itself asks for something different compared to the request received in step 402.

In step 404, the computing device may receive a response to a content request that comprises a manifest. The manifest may be in response to the request sent in step 403. For example, the computing device may receive, from a content source, a first manifest corresponding to the content. That said, the manifest received in step 404 might not be fully responsive to the request sent in step 403. For example, the manifest might comprise information about segments 720p and lower, whereas the request in step 403 might have requested 1080p segments. As another example, the manifest might comprise information for standard dynamic range content, whereas the request in step 403 might have requested HDR segments.

In step 405, the computing device may determine whether there is a difference between requested properties of the content and properties of the response received in step 404. This process may comprise comparing, by the computing device, a resolution, bit rate, bit depth, dynamic range, codec, or other properties of the requested content as compared to the response (e.g., the manifest) received in step 404. Such a comparison might comprise comparing the differences to a threshold, such that minor differences (e.g., a difference in 10 kbps in a bit rate) may be tolerable, but major differences (e.g., 1080p versus 720p) might not. Along those lines, the threshold may be defined by specifying acceptable differences. For example, a threshold may be established such that any difference in resolution (e.g., 480p vs 720p) satisfies the threshold, such that major differences in dynamic range (e.g., SDR instead of HDR, but not HDR400 vs HDR600) satisfy the threshold, and such that over 100 kbps of difference in bit rate satisfies the threshold. If there are differences (e.g., if the differences satisfy a threshold), the method 400 may proceed to step 407. Otherwise, if the differences do not satisfy the threshold, the method 400 may proceed to step 406.

In step 406, and based on determining that the differences do not satisfy the threshold, the computing device may send the received manifest. In this situation, the manifest received from a content source may be sufficiently responsive to the request from the requesting device such that the manifest can be sent directly to the requesting device. For example, the computing device may send, to the requesting device, a manifest received from the content source.

In step 407, and based on determining differences in step 405 (e.g., that the differences satisfy a threshold), the computing device may determine whether a responsive manifest is stored (in, e.g., the manifest database 306). A responsive manifest may comprise a manifest that satisfies the request from the requesting device received in step 402. For example, if the requesting device 301 requested 1080p content and a content source of the one or more content sources 303 responded with a manifest file containing only 480p segments of the content, then the computing device may determine whether a manifest file is stored (e.g., in the manifest database 306) that satisfies the 1080p content request (e.g., that contains 1080p segments for the content). If a responsive manifest is stored, the method 400 may proceed to step 408. Otherwise, the method 400 may proceed to step 409.

In step 408, and based on determining that a responsive manifest is stored, the computing device may send the stored responsive manifest. In this circumstance, the computing device may send, to the requesting device, a stored manifest in lieu of the manifest received from the content source. This process may thereby intercept the transmission of the manifest from a content source and replaces it with a more responsive manifest. For example, the computing device may, based a difference between properties indicated in the first manifest and properties corresponding to the first version of the content, and based on previous receipt of a second manifest corresponding to the content, send, to the requesting device, the second manifest.

As a brief introduction, step 409 and step 410 describe a process whereby the computing device may retrieve one or more manifests in addition to those described in previous steps. This process may be performed in circumstances where, for instance, neither the stored manifests nor the manifest provided by the one or more content sources 303 are satisfactorily responsive to a request received from the requesting device 301. For example, step 409 and step 410 may be performed where the requesting device 301 sends a request for a 4K version of video content, but the one or more content sources 303 provide manifests for only 1080p, and wherein the manifest database 306 does not store any better manifests (e.g., stores a previously-received manifest with 480p, but not the requested 4K).

In step 409, and based on determining that a responsive manifest is not stored, the computing device may send an additional content request. As such, in step 409, the computing device may attempt to acquire additional manifest(s) such that, even when available manifests are not responsive, the computing device attempts to acquire more manifests that are likely to be responsive to a content request. For example, the computing device may send, to the one or more content sources 303, one or more additional requests, thereby prompting the one or more content sources 303 to send additional manifests.

The additional requests sent by the computing device in step 409 need not be the same or similar as those sent in, for example, step 403. It may be desirable for the computing device to use one or more techniques to, in effect, prompt the one or more content sources 303 to provide the desired manifest, even if the request is significantly different from that originally provided by the requesting device 301. For example, the requesting device 301 may originally request a 1080p version of a movie in step 402, and, in response to the request sent in step 403, the one or more content sources 303 may respond with a manifest that only provides 720p and lower segments of the movie. In other words, in this example, the one or more content sources 303 might be trying to lower bandwidth expenditures by providing a resolution lower than a requested resolution. In such a circumstance, in step 409, the computing device may send a new request for the movie at 4K, which might prompt the one or more content sources 303 to respond with a manifest comprising 1080p and lower segments of the movie.

In step 410, the computing device may receive an additional manifest in response to the additional content request. The additional manifest may be received in the same or similar manner as the manifest received in step 404, but need not be from the same content source. For example, the manifest received in step 404 may be received from the content source A 304a of the one or more content sources 303, whereas the manifest received in step 410 may be received from the content source B of the one or more content sources 303. In this manner, even if one content source (e.g., the content source A 304a) does not have access to content in a manner requested by the requesting device 301, a different content source of the one or more content sources 303 might be prompted to indicate if it has the requested format.

In step 411, the computing device may store one or more manifests received as part of the method 400. To maintain a history of manifests (e.g., in the manifest database 306), the computing device may store manifests received as part of one or more of the steps above, such as step 404 and/or step 410. In this manner, even if a manifest received from the one or more content sources 303 is not used (e.g., provided to the requesting device 301), the manifest may be stored such that it might be used for later requests (and, e.g., from the same or different requesting devices).

The method 400 may be repeated over time for various different content requests, which may advantageously allow for a collection of a larger/more robust history of manifests. For example, the computing device may receive, from the requesting device, a second request for a first version of a second content, then request, from the content source, the first version of the second content. In response, the computing device may receive a third manifest corresponding to the second content. The computing device may then send, to a requesting device and based on comparing the properties indicated in the third manifest and properties corresponding to the first version of the second content, the third manifest. Additionally, the computing device may store the third manifest.

FIG. 5 shows an example database listing 500 of manifests that might be stored in the manifest database 306. Specifically, FIG. 5 depicts columns including an ID column 501, a channel ID column 502, a quality column 503, a highest available column 504, and a URI column 505. The ID column 501 may be used to indicate an internal identifier for (e.g., a unique string representing) content. The channel ID column 502 may be used to indicate a channel associated with a particular content (where applicable, as content need not be delivered via channels). For example, if content (e.g., a news report) corresponds to a particular channel (e.g., the channel A 305a), then an entry for a row corresponding to the channel ID column 502 may indicate the association between the content and the channel. The quality column 503 may correspond to a quality indicated in a manifest, and the highest available column 504 may indicate whether the quality is the highest available form of the content. As such, a single manifest might have multiple entries in the database listing 500, with various rows corresponding to different formats of the content indicated in the manifest, and with one of those rows (e.g., the 4K or 8K version) indicating the highest available form of the content. The URI column 505 may indicate a URI corresponding to one or more segments for the quality indicated in the quality column 503. In other words, the URI column 505 may correspond to, in a row, the URIs where various segments of content at a particular quality can be retrieved (e.g., by the requesting device 301).

To provide an example of how the database listing 500 may be used, as part of step 407 (where the computing device determines whether a responsive manifest is stored), the computing device may determine, using the database listing 500, whether a responsive manifest is stored in the manifest database 306. For example, in response to a request for a 1080p form of content A available on channel 430, the computing device may query the database listing 500 and identify two rows corresponding to content A: a first row 506a for a 480p version of the content, and a third row 506c for a 1080p version of the content. In contrast, while a third row-corresponding to content B on channel 525 in 4K-might be stored by the database listing 500, it might not be responsive to the aforementioned request. In such an example, the computing device may identify that the third row 506c is responsive to the request for a 1080p form of the content and may transmit one or more manifests corresponding to that row to the requesting device 301.

FIG. 6 shows an example of files stored by the manifest database 306, including an Episode 1 (480p) Manifest 601a, an Episode 1 (720p) Manifest 601b, an Episode 1 (1080p) Manifest 601c, and an Episode 2 (720p) Manifest 601d. These manifests are examples of files that may be stored as part of step 401 and/or step 411 of FIG. 4, and which may be used (e.g., as part of step 407 and/or step 408 of FIG. 4) to respond to requests from requesting devices.

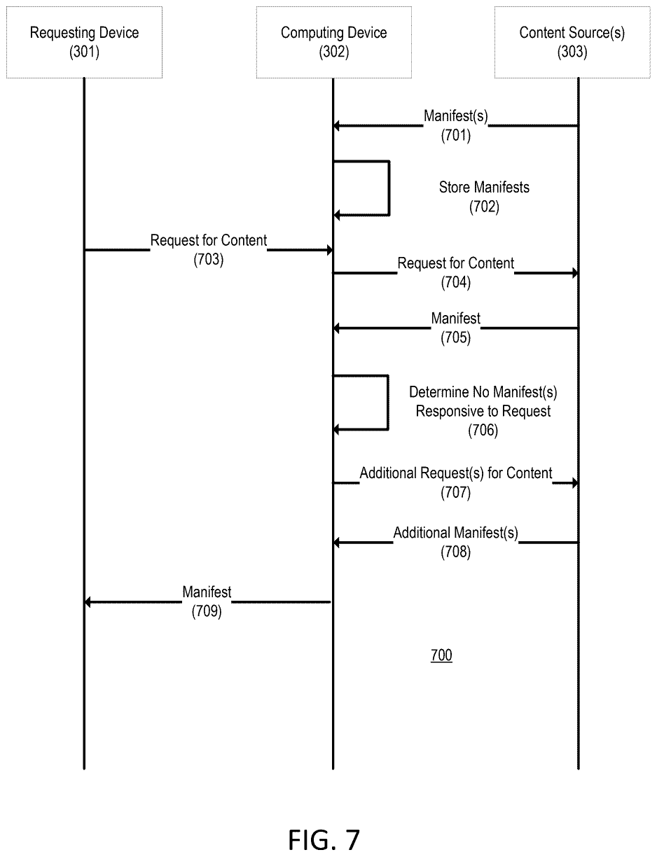

FIG. 7 shows a messaging diagram 700 illustrating examples of a process whereby additional manifests may be received. More particularly, the messaging diagram 700 shows illustrative messages between the requesting device 301, the computing device 302, and the one or more content sources 303 of FIG. 3. The messaging diagram 700 is illustrative and focuses on the particular circumstance where, in the context of the method 400 of FIG. 4, the answer to step 405 (whether there is a difference between the requested properties and the response manifest) is yes and the answer to step 407 (whether a responsive manifest is stored) is no, kicking off a process whereby the computing device seeks to collect one or more additional manifests.

As shown in the messaging diagram 700, the computing device 302 may receive manifests 701 and, in step 702, store the manifests as, for instance, a history of manifests. This process may be the same or similar as step 401 of FIG. 4. Then, the computing device 302 might receive a request for content 703 and send a corresponding request for content 704 to the one or more content sources 303. This process may be the same or similar as step 402 and step 403 of FIG. 4. The computing device 302 may then receive a manifest 705 from the one or more content sources 303 in a process similar to step 404 of FIG. 4. Then, in step 706, the computing device may determine that no manifests received from the one or more content sources 303 (e.g., as part of the manifests 701 stored in step 702 and/or the manifest 705) are responsive to the request for content 703. As indicated above, this may be similar to, in the context of the method 400 of FIG. 4, the answer to step 405 (whether there is a difference between the requested properties and the response manifest) being yes and the answer to step 407 (whether a responsive manifest is stored) being no. In such a circumstance, the computing device 302 may send one or more additional requests for content 707 to the one or more content sources 303, which may respond with one or more additional manifests 708. This process may be the same or similar as step 409 and/or step 410 of FIG. 4. At least one of those manifests, if responsive, may then be provided to the requesting device as manifest 709 in a process similar to step 406 and/or step 408 of FIG. 4.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
receiving, by a computing device, a first manifest corresponding to a first version of content;
receiving, by the computing device and from a requesting device, a request for the first version of the content;
requesting, from a content source:
the first version of the content, and
a second manifest corresponding to the content; and
sending, to the requesting device, the first manifest.

2. The method of claim 1, further comprising:
receiving, by the computing device, a request for a second version of the content; and
sending, to the requesting device and based on comparing properties indicated in the second manifest and properties corresponding to the second version of the content, the second manifest.

3. The method of claim 1, wherein the first manifest was received in response to a different request for the first version of the content.

4. The method of claim 1, further comprising:
receiving, by the computing device and from the requesting device, a second request for a first version of second content;
requesting, from the content source, the first version of the second content;
receiving, from the content source, a third manifest corresponding to the second content; and
sending, to the requesting device and based on comparing properties indicated in the third manifest and properties corresponding to the first version of the second content, the third manifest.

5. The method of claim 1, further comprising:
storing, in a database, a plurality of manifests corresponding to different content, wherein the sending the first manifest comprises identifying, in the database, the first manifest; and
storing, in the database, the second manifest.

6. The method of claim 1, wherein the sending the first manifest is based on a difference between properties indicated in the first manifest and properties corresponding to the first version of the content.

7. The method of claim 6, wherein the difference between the properties indicated in the first manifest and the properties corresponding to the first version of the content indicates that the first manifest corresponds to a lower resolution.

8. A method comprising:
storing, by a computing device, one or more first manifests received from one or more content sources, wherein one of the one or more first manifests are associated with a first content item;
receiving, by the computing device and from a requesting device, a request for a first version of the first content item;
requesting, from the one or more content sources, the first version of the first content item;
receiving, from one of the one or more content sources, a second manifest corresponding to the first version of the first content item;
comparing properties of the first content item described in the one of the one or more stored manifests to properties of the first version of the first content item described in the second manifest; and
based on comparing, sending, to the requesting device, the one of the one or more first manifests associated with the first content item.

9. The method of claim 8, wherein the one or more first manifests are received from a first content source of the one or more content sources, and wherein the second manifest is received from a second content source of the one or more content sources.

10. The method of claim 8, wherein the second manifest corresponds to a different resolution as compared to the one or more first manifests.

11. The method of claim 8, further comprising:
storing, in a database comprising a plurality of manifests corresponding to a plurality of different contents, one or both of:
the one or more first manifests, or
the second manifest.

12. The method of claim 8, further comprising:
sending, based on determining that the one or more first manifests correspond to a greater content resolution as compared to the second manifest, the one or more first manifests to a second computing device.

13. The method of claim 8, wherein the sending the one or more first manifests is further based on a determination that one or more files indicated by the first manifest are accessible by the requesting device.

14. The method of claim 8, wherein the sending the one or more first manifests is further based on a time when the one or more first manifests were received.

15. A method comprising:
storing, by a computing device, a first manifest received from one or more content sources in response to a previous request for a first content item;
receiving, by the computing device and from a requesting device, a request for a first version of the first content item;
based on properties of the first content item described in the first manifest not satisfying a threshold:
sending, to the one or more content sources, a modified request for the first version of the content;
receiving, from the one or more content sources, a second manifest; and
sending, to a requesting device, the second manifest.

16. The method of claim 15, further comprising:
receiving, by the computing device, a request for a second version of the content; and
sending, to the requesting device, the first manifest.

17. The method of claim 15, further comprising:
receiving, by the computing device and from a second requesting device, a different request for the first version of the content; and
sending, in response to the different request, the second manifest.

18. The method of claim 15, further comprising:
receiving, by the computing device and from the requesting device, a request for a first version of a second content;
receiving, from at least one of the one or more content sources, a third manifest corresponding to the second content; and
sending, to the requesting device, the third manifest.

19. The method of claim 15, wherein the computing device is configured to store manifests for each version of a plurality of different contents.

20. The method of claim 15, wherein the properties of the first content item described in the first manifest comprise one or more of:
resolution, or
bit rate.
